(19) United States
(12) Patent Application Publication
(10) Pub. No.: US 2025/0364662 A1
(43) Pub. Date: Nov. 27, 2025

(54) FLEXIBLE BATTERY SYSTEM FOR CURVED SURFACE APPLICATIONS

(71) Applicant: NIKE, Inc., Beaverton, OR (US)

(72) Inventors: Joseph B. Gault, West Linn, OR (US); Andrew C. Lau, Happy Valley, OR (US); Jazzmin P. Martinez, Beaverton, OR (US); Austin J. Orand, Portland, OR (US); Jan Raken, Seattle, WA (US); Daniel Weeks, Portland, OR (US)

(73) Assignee: NIKE, Inc., Beaverton, OR (US)

(21) Appl. No.: 19/219,754

(22) Filed: May 27, 2025

Related U.S. Application Data
(60) Provisional application No. 63/651,940, filed on May 24, 2024.
(60) Provisional application No. 63/651,435, filed on May 24, 2024.

(51) Int. Cl. H01M 50/247; A41D 1/00; H01M 10/42; H01M 10/613; H01M 10/6551; H01M 10/658; H01M 50/204; H01M 50/238; H01M 50/24; H01M 50/242; H01M 50/503; H01M 50/524

(52) U.S. Cl. CPC H01M 50/247; A41D 1/002; H01M 10/425; H01M 10/613; H01M 10/6551; H01M 10/658; H01M 50/204; H01M 50/238; H01M 50/24; H01M 50/242; H01M 50/503; H01M 50/524; H01M 2010/4271; H01M 2220/30

(57) ABSTRACT

A flexible battery system for wearable and robotic applications comprises rigid or semi-rigid battery cells interconnected by flexible interconnection sections that enable conformability to curved contours while maintaining electrical connectivity. Each flexible interconnection section includes a flexible substrate with embedded conductive elements such as conductive traces, wires, or accordion-folded materials. The system includes a protective encapsulation layer and the battery cells may be arranged in linear, circular, or matrix configurations, including auxetic patterns for enhanced three-dimensional conformability.

### CROSS-REFERENCE TO RELATED APPLICATION

This application claims the benefit of priority to U.S. Provisional Application No. 63/651,940, filed May 24, 2024, and U.S. Provisional Application No. 63/651,435, filed May 24, 2024, both of which are incorporated by reference in their entirety.

### TECHNICAL FIELD

The present disclosure relates generally to power supply systems for wearable technology, and more particularly to flexible battery systems configured to conform to curved surfaces including contours of the human body while maintaining electrical performance for applications in apparel, wearable devices, and articulated robotic systems.

### BACKGROUND

Electronic assist devices and wearable technology have gained increasing adoption across consumer, athletic, and professional applications. However, power supply systems for wearable devices face significant design constraints when required to conform to body contours and accommodate dynamic movement during use. Conventional battery designs typically employ rigid structures that limit integration possibilities in applications where power sources must adapt to curved surfaces. This rigidity creates design challenges for wearable technology including smart garments, athletic monitoring apparel, heated clothing, and medical devices where optimal user experience requires power sources that conform to anatomical contours.

The inflexibility of conventional battery systems forces product designers to accommodate rigid power sources rather than allowing batteries to adapt to optimal product designs. This constraint becomes particularly limiting in applications requiring distributed power around circumferential body areas or in systems where weight distribution and comfort during dynamic movement are critical considerations.

There exists a need for power supply systems that can achieve conformability to curved surfaces while maintaining reliable electrical performance, particularly for applications in apparel and wearable devices where user comfort, weight distribution, and accommodation of body movement are essential design requirements.

### SUMMARY

The present disclosure provides a flexible battery system designed to conform to curved surfaces, particularly body contours, while maintaining reliable power delivery characteristics for wearable applications. The system addresses the design constraints of conventional rigid battery systems by providing conformability through engineered flexible interconnection sections while preserving electrical performance.

The flexible battery system comprises a plurality of rigid or semi-rigid battery cells arranged in a predetermined pattern, a plurality of flexible interconnection sections connecting adjacent battery cells and providing electrical connectivity between them, and a protective encapsulation layer surrounding at least portions of the battery cells and the flexible interconnection sections. The flexible interconnection sections enable the flexible battery system to conform to body contours while maintaining electrical connectivity between the battery cells.

In certain embodiments, each flexible interconnection section comprises a flexible substrate with embedded conductive elements. The flexible substrate may comprise polyimide film, silicone elastomer, or thermoplastic polyurethane, while the embedded conductive elements may include conductive traces, conductive wires, spring-like connectors, or accordion-folded conductive materials designed to maintain electrical continuity during repeated bending cycles. Some embodiments may include strain relief features at the junctions of the flexible interconnection sections and the battery cells.

The battery cells may be arranged in various configurations including linear, circular, or matrix patterns to suit different applications. In specific embodiments, the matrix configuration comprises an auxetic matrix pattern configured to provide enhanced three-dimensional conformability. The battery cells may utilize various chemistries including lithium-ion, lithium-polymer, nickel-metal hydride, advanced alkaline, or solid-state battery technologies. The protective encapsulation layer may comprise multiple layers, such as an inner moisture barrier, a middle impact protection layer, and an outer abrasion-resistant layer, and may also include an outer surface of foam or padded fabric for enhanced comfort.

In another aspect, an article of apparel incorporates the flexible battery system secured to a garment structure through a garment attachment mechanism. The garment attachment mechanism may comprise clips, magnetic connectors, hook-and-loop fasteners, slide-in channels, or elastic bands, and may be configured to removably secure the flexible battery system to facilitate battery charging without removing the garment structure. The flexible battery system may be integrated into garment elements such as waistbands, cuffs, collars, side panels, or dedicated power pockets.

In a further aspect, an athletic garment specifically incorporates the flexible battery system configured to accommodate dynamic body movement during physical activity. The system includes thermal management features configured to maintain the battery cells within predetermined temperature ranges during physical activity, and a protective encapsulation layer that shields the battery cells and flexible interconnection sections from perspiration and mechanical stress.

The flexible battery system may further include electrical interface connectors positioned at predetermined locations, a thermistor wire integrated for temperature monitoring and mechanical failure detection, and a battery management system configured to monitor cell health and optimize performance during operation.

Alternative applications include integration with robotic systems, such as articulated robotic arms, soft robotics applications, and assistive exoskeleton devices, where conformable power distribution enhances operational performance. The flexible battery system enables new design possibilities across athletic, outdoor, professional, medical, lifestyle, and robotic product categories by allowing power sources to adapt to anatomical or structural contours and movement patterns rather than imposing rigid form factor constraints.

### BRIEF DESCRIPTION OF THE DRAWINGS

The accompanying drawings, which are incorporated in and constitute a part of this specification, illustrate various embodiments of the flexible battery system and, together with the detailed description, serve to explain the principles of the design.

FIG. 1 is a perspective view of a flexible battery system conforming to a curved surface in accordance with an embodiment of the present disclosure.

FIG. 2 is an exploded view of the flexible battery system of FIG. 1, illustrating the internal components and their arrangement.

FIG. 3 is a cross-sectional view of the flexible battery system taken along line 3-3 of FIG. 1, showing the protective encapsulation layer with multiple protective layers.

FIG. 4 is a detailed view of a flexible interconnection section showing a flexible substrate with embedded conductive elements, strain relief features, and a thermistor wire.

FIG. 5 is a schematic perspective view of an electrical interface connector on the flexible battery system.

FIG. 6 is a schematic view illustrating the flexible battery system integrated with robotic applications including an assistive exoskeleton.

### DETAILED DESCRIPTION

The present disclosure is directed to a flexible battery system designed to conform to curved surfaces, particularly body contours, while providing reliable electrical power for wearable applications including apparel and robotic systems. The following detailed description refers to the accompanying figures, wherein like reference numerals refer to like elements throughout the various views.

### System Overview

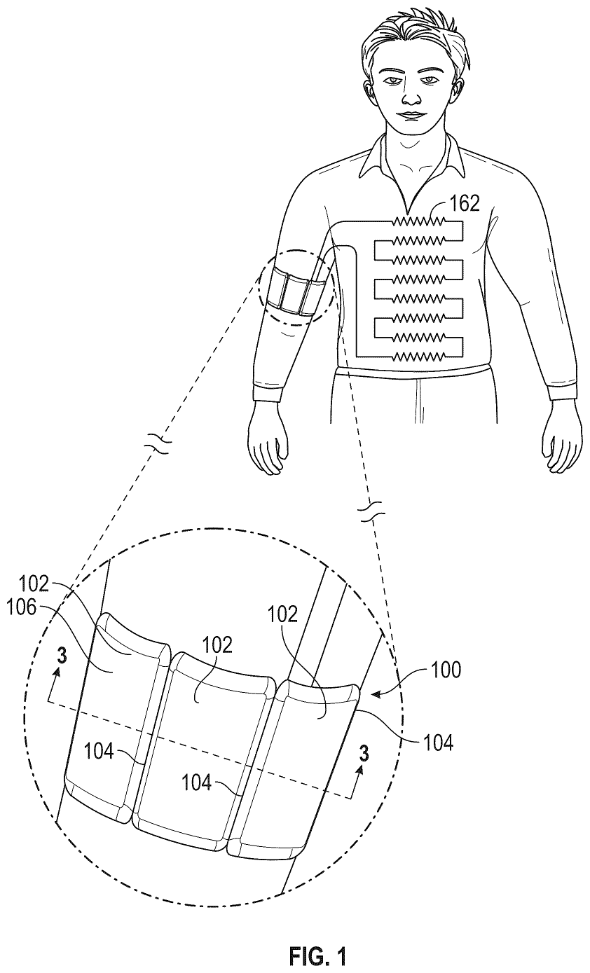

Referring to FIG. 1, a flexible battery system 100 is illustrated in a perspective view showing its capability to conform to a curved surface. The flexible battery system 100 comprises a plurality of rigid or semi-rigid battery cells 102 interconnected by a plurality of flexible interconnection sections 104. The entire assembly is surrounded by a protective encapsulation layer 106 that shields the internal components while preserving the system's flexibility. This configuration enables the battery system 100 to bend along predetermined axes to conform to curved surfaces such as the contours of a human body. The system can power various electronic components 162 integrated with a garment or device.

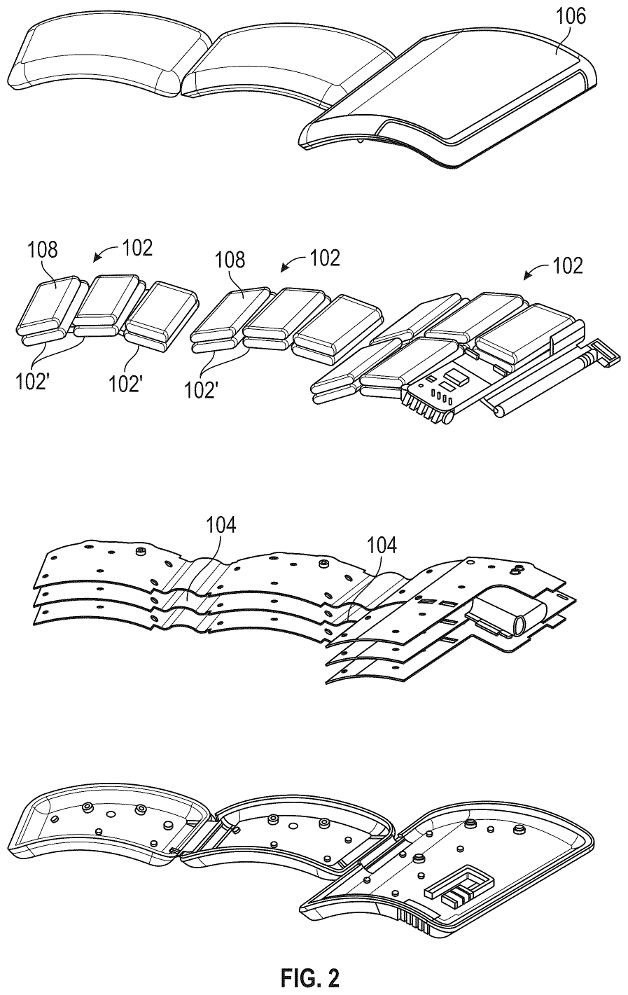

FIG. 2 provides an exploded view of the flexible battery system 100, revealing the internal components and their arrangement. Each rigid or semi-rigid battery cell 102 may be formed from one or more discrete cells 102′ contained within a modified protective housing 108. Adjacent battery cells 102 are connected by flexible interconnection sections 104 that provide both mechanical articulation and electrical connectivity. The protective encapsulation layer 106 surrounds the assembly to protect against external elements while maintaining flexibility.

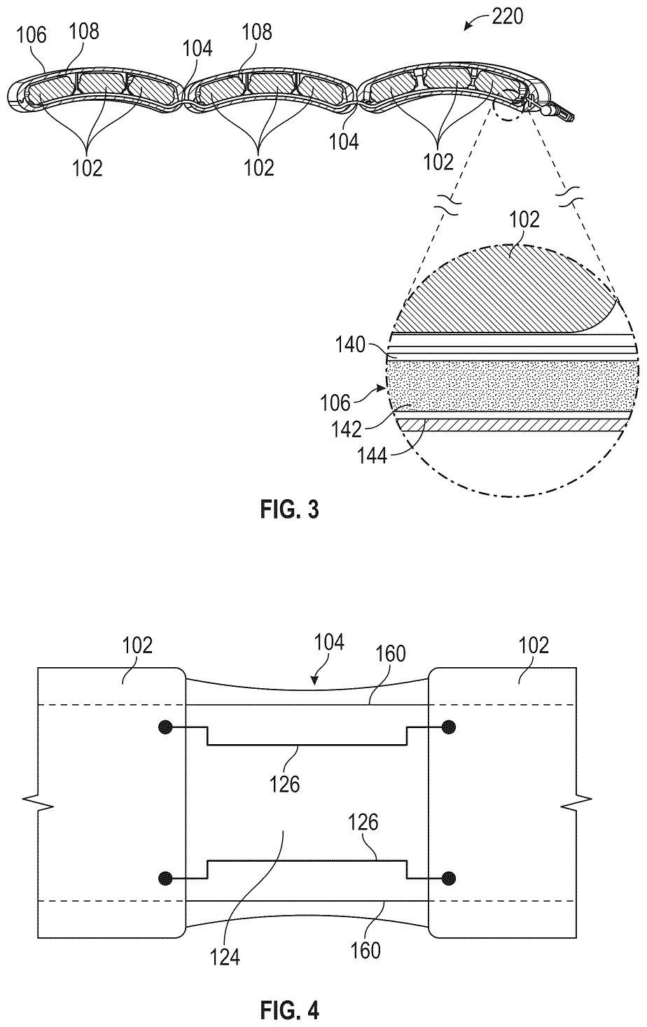

As illustrated in FIG. 3, which provides a cross-sectional view of the flexible battery system 100 taken along line 3-3 of FIG. 1, each battery cell 102 maintains its internal rigidity while the flexible interconnection sections 104 enable bending of the overall assembly 220. The protective encapsulation layer 106, visible in this cross-sectional view, encompasses both the battery cells 102 and flexible interconnection sections 104 to provide environmental protection and structural support. In some embodiments, the protective encapsulation layer 106 may comprise multiple layers including an inner moisture barrier 140, a middle impact protection layer 142, and an outer abrasion-resistant layer 144. The materials selected for the protective encapsulation layer 106 may include polymer laminates, elastomeric coatings, or specialized composite materials that provide the necessary protection while permitting the required flexibility. The thickness of such layers might range, for example, from a few tens of micrometers to several millimeters, depending on the specific material and required level of protection and flexibility. In certain embodiments, the outer surface of the encapsulation layer may incorporate a foam or padded fabric to enhance comfort when the battery system is worn against the body.

### Battery Cell Construction

The rigid or semi-rigid battery cells 102 may be constructed using various chemistries depending on the specific requirements of the intended application. Suitable technologies include lithium-ion, lithium-polymer, nickel-metal hydride, advanced alkaline, or emerging solid-state battery chemistries. Each battery cell 102 includes a cell housing 108 containing internal components including an anode, a cathode, and an electrolyte or separator. The cell housing 108 is constructed from materials that maintain structural integrity while being lightweight enough for wearable applications. The internal components utilize conventional battery chemistry to maximize energy density within each cell while maintaining safety parameters appropriate for body-worn applications.

The battery cells 102 may be arranged in various configurations, including linear, circular, or matrix patterns. The specific arrangement is selected based on the intended application and required conformability. In a linear configuration, the cells form a single line suitable for wrapping around cylindrical body parts. In a circular configuration, the cells form a closed loop that can surround a limb or torso. In a matrix configuration, the cells form a two-dimensional array that can conform to complex curved surfaces. In certain embodiments, the matrix configuration comprises an auxetic matrix pattern that provides enhanced three-dimensional conformability through engineered geometric arrangements that expand in multiple directions when stretched, enabling adaptation to surfaces with multiple curvatures such as shoulders, elbows, knees, or a curved back. This two-dimensional articulation capability makes the system particularly suitable for complex anatomical regions.

### Flexible Interconnection Sections

The flexible interconnection sections 104 connecting adjacent battery cells 102 serve the dual purpose of providing mechanical articulation and maintaining electrical connectivity throughout the battery assembly. As illustrated in FIG. 4, each flexible interconnection section 104 comprises a flexible substrate 124 with embedded conductive elements 126. The flexible substrate 124 may be constructed from materials including, but not limited to, polyimide film, silicone elastomer, or thermoplastic polyurethane (TPU). The thickness of the flexible substrate can vary, for instance, from tens of micrometers to a few millimeters, depending on the material and desired flexibility.

The conductive elements 126 embedded within the flexible substrate 124 may take various forms to accommodate repeated bending cycles without fatigue failure during normal wear. These elements may include conductive traces, conductive wires, spring-like connectors, or accordion-folded conductive materials. These elements are designed to maintain electrical continuity while accommodating the mechanical stresses associated with dynamic body movement and conformational changes.

In some embodiments, the flexible interconnection sections 104 may further incorporate strain relief features at the junctions with the rigid or semi-rigid battery cells 102. These features may include graduated flexibility zones that distribute bending stress and prevent concentration at a single point, thereby enhancing durability during repeated flexing cycles.

The battery cells 102 are electrically coupled via the conductive elements 126 within the flexible interconnection sections 104 in series, parallel, or series-parallel configurations depending on voltage and current requirements of the intended application. Typical voltage ranges for wearable applications span from approximately 3.7 volts for single-cell configurations to 12-24 volts for multi-cell arrangements, though specific parameters are optimized based on the electronic components being powered.

### Electrical Interface and Monitoring Systems

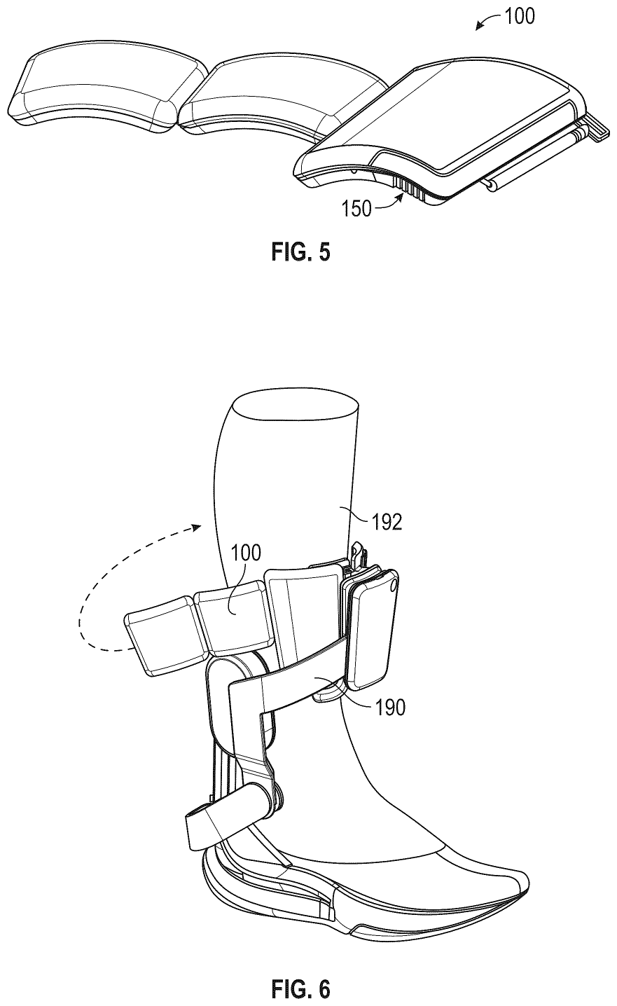

As shown in FIG. 5, the battery system 100 may include electrical interface connectors 150 positioned at strategic locations to facilitate connection with powered components or charging equipment. These connectors may include standard interfaces such as USB Type-C ports, wireless induction coils, or application-specific connectors depending on the intended use.

In certain embodiments, the flexible battery system 100 incorporates a thermistor wire 160 (as generally shown in FIG. 4 integrated within flexible interconnection section 104) integrated with the flexible battery system for temperature monitoring and mechanical failure detection. The thermistor wire 160 may traverse the flexible interconnection sections 104 between adjacent cells, allowing it to serve the dual function of temperature monitoring and mechanical integrity verification. An open circuit in the thermistor wire 160 would indicate a break in the battery system's physical integrity, providing an early warning system for potential failures.

The flexible battery system 100 may further incorporate thermal management features to maintain safe operating temperatures despite proximity to body heat or variable environmental conditions. These features may include heat-dissipating materials, insulation layers, or active cooling elements in high-power applications. Safe operating temperatures are crucial, often within typical operating temperature ranges for wearable electronics (e.g., approximately 0° C. to 50° C. ambient, with internal temperatures managed accordingly to stay within cell manufacturer specifications, which might be, for example, −20° C. to 60° C. for operation and narrower for charging). Temperature management is particularly critical in athletic applications where body heat and ambient conditions may vary significantly during use.

Integration with Wearable Applications

The flexible battery system 100 is configured for integration into various articles of apparel. As shown in FIG. 1, the battery system conforms to the curvature of the wearer's body, distributing weight around the circumference rather than concentrating it at a single location. This configuration improves comfort and stability during movement while maintaining power supply to electronic components 162 such as sensors, heating elements, communication systems, lighting elements, or computing devices integrated with the garment.

As conceptually illustrated in FIG. 6 with respect to robotic applications, a similar garment attachment mechanism (not explicitly numbered but implied for apparel) would secure the battery to an article of apparel. Such garment attachment mechanisms may comprise clips, magnetic connectors, hook-and-loop fasteners, slide-in channels, or elastic bands designed to accommodate different garment types and user preferences. In many embodiments, the garment attachment mechanism is configured to removably secure the flexible battery system 100 to the garment structure, facilitating battery charging without requiring removal of the entire garment. This removable configuration enhances user convenience and enables washing of the garment while protecting the electronic components.

In specific embodiments, the flexible battery system 100 may be integrated directly into garment elements such as waistbands, cuffs, collars, side panels, or dedicated power pockets. This integration enables the battery system to follow the natural contours of the body while powering electronic components within the garment structure.

For athletic garment applications, the flexible battery system 100 is specifically configured to accommodate dynamic body movement during physical activity while powering performance-related electronic components. The protective encapsulation layer 106 in athletic applications provides enhanced protection against perspiration and mechanical stress through specialized moisture-wicking materials and impact-resistant compositions. Electronic components powered by the system in athletic applications include performance monitoring sensors, biometric sensors, heating elements, cooling elements, lighting elements, or communication devices. The flexible battery system 100 in athletic garments is arranged in distribution patterns that distribute weight circumferentially around the body to reduce localized pressure points during athletic movement. This weight distribution strategy minimizes interference with natural movement patterns while maintaining reliable power delivery throughout the range of athletic activities.

### Battery Management and Control Systems

The flexible battery system 100 incorporates a battery management system (BMS) configured to monitor cell health and optimize performance of the battery cells 102 during operation. The BMS includes circuitry for monitoring voltage, current, and temperature parameters of individual cells or cell groups, preventing overcharging or over-discharging conditions, and optimizing charging cycles to maximize battery life. In athletic applications, the BMS adapts charging and discharging parameters based on activity levels, environmental conditions, and power demands of connected electronic components. This adaptive management ensures reliable operation throughout extended periods of physical activity while maintaining safety parameters appropriate for body-worn applications.

### Alternative Applications (Robotic Systems)

While particularly advantageous for apparel applications, the flexible battery system 100 may also be utilized in other applications requiring power sources that conform to curved surfaces. For example, as shown in FIG. 6, the flexible battery system 100 may be integrated with an articulated robotic arm, soft robotics system, or assistive exoskeleton 190 (which may be a wearable robotic assistive device for a human limb 192), conforming to the changing geometry during operation.

In articulated robotic systems with multiple degrees of freedom, the flexible battery system 100 may be integrated along the length of moving components, conforming to the changing geometry during operation. The rigid battery cells 102 would be positioned to avoid the primary articulation points, while the flexible interconnection sections 104 would align with the robot's joints or bending zones. This configuration allows power to be distributed throughout the robotic structure rather than concentrated in a central battery compartment, potentially improving weight distribution, balance, and operational duration without restricting movement range.

For assistive exoskeletons 190 or wearable robotic assistive devices, the flexible battery system 100 can be integrated directly into structural components that wrap around human limbs 192 or components of the exoskeleton itself. By conforming to both the exoskeleton's contours and potentially the user's body shape, the battery distributes weight more evenly and reduces bulk compared to conventional battery packs. This integration is particularly valuable in medical rehabilitation robots, where comfort and ergonomics are critical considerations alongside technical performance. In humanoid robots with curved chassis designs, the flexible battery system 100 can conform to complex three-dimensional surfaces, utilizing space that would be inaccessible to conventional rigid batteries.

### Operation

In operation, the flexible battery system 100 provides electrical power to connected devices while conforming to curved surfaces and accommodating movement. The rigid or semi-rigid battery cells 102 maintain their internal structure and energy storage capabilities while the flexible interconnection sections 104 allow the overall assembly to bend and flex along predetermined axes without compromising electrical connectivity.

When integrated with apparel or wearable devices, the flexible battery system 100 adapts to the contours of the wearer's body, distributing weight more evenly and reducing pressure points compared to conventional rigid batteries. During movement, the flexible interconnection sections 104 accommodate dynamic changes in body contours while maintaining reliable electrical connectivity between the battery cells 102 and powered components.

The integrated battery management system continuously monitors the condition of the battery cells 102, adjusting charging and discharging parameters as needed to optimize performance and ensure safety. The thermal management features maintain appropriate operating temperatures despite variable conditions including body heat during physical activity or external environmental factors.

For recharging, the flexible battery system 100 may be removed from the wearable application using a garment attachment mechanism, or charged in place using the electrical interface connectors 150. The protective encapsulation layer 106 shields the internal components during both wear and charging operations, protecting against moisture, impact, and other potential hazards.

While specific embodiments of the flexible battery system have been described, various modifications, alterations, and adaptations may be made without departing from the spirit and scope of the present disclosure. The specific arrangement of cells, materials used for flexible interconnections, and encapsulation techniques may be modified to suit particular applications or to incorporate emerging technologies while embodying the core principles of the flexible battery system described herein.

Additional disclosure of features and alternate/additional uses for the flexible battery are described in U.S. patent application Ser. No. 19/219,653, filed 27 May 2025, entitled Motorized Ambulatory Assist Device, the entire disclosure of which is incorporated by reference in its entirety and for everything that it discloses.

1. A flexible battery system for wearable applications comprising:
a plurality of rigid or semi-rigid battery cells arranged in a predetermined pattern;
a plurality of flexible interconnection sections, each flexible interconnection section connecting adjacent battery cells in the predetermined pattern and providing electrical connectivity between the adjacent battery cells; and
a protective encapsulation layer surrounding at least portions of the battery cells and the flexible interconnection sections;
wherein the flexible interconnection sections enable the flexible battery system to conform to a body contour while maintaining electrical connectivity between the battery cells.

2. The flexible battery system of claim 1, wherein each flexible interconnection section comprises a flexible substrate with embedded conductive elements.

3. The flexible battery system of claim 2, wherein the flexible substrate comprises at least one of: polyimide film, a silicone elastomer, or a thermoplastic polyurethane.

4. The flexible battery system of claim 2, wherein the embedded conductive elements comprise at least one of: conductive traces, conductive wires, spring-like connectors, or accordion-folded conductive materials.

5. The flexible battery system of claim 2, wherein the flexible interconnection sections further incorporate strain relief features at junctions with the rigid or semi-rigid battery cells.

6. The flexible battery system of claim 1, wherein the plurality of battery cells are arranged in at least one of: a linear configuration, a circular configuration, or a matrix configuration.

7. The flexible battery system of claim 6, wherein the matrix configuration comprises an auxetic matrix pattern configured to provide three-dimensional conformability.

8. The flexible battery system of claim 1, wherein the rigid or semi-rigid battery cells comprise at least one of: lithium-ion cells, lithium-polymer cells, nickel-metal hydride cells, advanced alkaline cells, or solid-state battery cells.

9. The flexible battery system of claim 1, wherein the protective encapsulation layer comprises an inner moisture barrier, a middle impact protection layer, and an outer abrasion-resistant layer.

10. The flexible battery system of claim 9, wherein an outer surface of the protective encapsulation layer incorporates a foam or padded fabric.

11. The flexible battery system of claim 1, further comprising:
electrical interface connectors positioned at predetermined locations on the flexible battery system; and
a thermistor wire integrated with the flexible battery system and traversing at least one of the flexible interconnection sections between adjacent battery cells for temperature monitoring and mechanical failure detection.

12. An article of apparel comprising:
a garment structure configured to be worn on a body;
a flexible battery system secured to the garment structure, the flexible battery system comprising:
a plurality of rigid or semi-rigid battery cells arranged in a predetermined pattern,
a plurality of flexible interconnection sections connecting adjacent battery cells and providing electrical connectivity between the adjacent battery cells, and
a protective encapsulation layer surrounding at least portions of the battery cells and the flexible interconnection sections; and
a garment attachment mechanism configured to secure the flexible battery system to the garment structure; and
wherein the flexible battery system conforms to body contours when the garment structure is worn.

13. The article of apparel of claim 12, wherein the garment attachment mechanism comprises at least one of: clips, magnetic connectors, hook-and-loop fasteners, slide-in channels, or elastic bands.

14. The article of apparel of claim 12, wherein the garment attachment mechanism is configured to removably secure the flexible battery system to the garment structure to facilitate battery charging without removing the garment structure.

15. The article of apparel of claim 12, further comprising at least one electronic component integrated with the garment structure and electrically connected to the flexible battery system.

16. The article of apparel of claim 15, wherein the at least one electronic component comprises at least one of: heating elements, lighting elements, sensors, communication devices, or computing devices.

17. The article of apparel of claim 12, wherein the flexible battery system is integrated into at least one of: a waistband, a cuff, a collar, a side panel, or a dedicated power pocket of the garment structure.

18. The article of apparel of claim 12, wherein the flexible battery system is arranged to distribute weight circumferentially around a portion of the body when the garment structure is worn.

19. An athletic garment comprising:
a garment structure configured to be worn on a body during physical activity;
a flexible battery system secured to the garment structure, the flexible battery system comprising:
a plurality of rigid or semi-rigid battery cells arranged in a predetermined pattern,
a plurality of flexible interconnection sections connecting adjacent battery cells and providing electrical connectivity between the adjacent battery cells,
a protective encapsulation layer that shields the battery cells and flexible interconnection sections from perspiration and mechanical stress,
thermal management features configured to maintain the battery cells within a predetermined temperature range during physical activity;
electronic components integrated with the athletic garment and powered by the flexible battery system; and
wherein the flexible battery system is configured to conform to body contours and accommodate body movement during physical activity.

20. The athletic garment of claim 19, wherein the electronic components comprise at least one of: performance monitoring sensors, biometric sensors, heating elements, cooling elements, lighting elements, or communication devices.

21. The athletic garment of claim 19, wherein the flexible battery system is arranged in a distribution pattern that distributes weight circumferentially around the body to reduce localized pressure points during athletic movement.

22. The athletic garment of claim 19, wherein the thermal management features comprise at least one of: heat-dissipating materials, insulation layers, or active cooling elements.

23. The athletic garment of claim 19, further comprising a battery management system configured to monitor cell health and optimize performance of the battery cells during physical activity.
